(19) United States
(12) Patent Application Publication
(10) Pub. No.: US 2026/0134527 A1
(43) Pub. Date: May 14, 2026

(54) SYSTEMS AND METHODS FOR CONDITIONAL VIDEO DIFFUSION RELIGHTING

(71) Applicant: Netflix, Inc., Los Gatos, CA (US)

(72) Inventors: Yiqun Mei, San Jose, CA (US); Mingming He, Los Angeles, CA (US); Li Ma, Los Angeles, CA (US); Julien Olivier Victor Philip, London (FR); Wenqi Xian, Los Angeles, CA (US); David M. George, Cerritos, CA (US); Xueming Yu, South Pasadena, CA (US); Gabriel Dedic, Duesseldorf (DE); Ahmet Levent Tasel, Vancouver (CA); Ning Yu, Los Angeles, CA (US); Paul E. Debevec, Culver City, CA (US)

(21) Appl. No.: 19/336,044

(22) Filed: Sep. 22, 2025

Related U.S. Application Data
(60) Provisional application No. 63/720,688, filed on Nov. 14, 2024.

(51) Int. Cl. G06T 5/92; G06T 5/60; G06T 5/70

(52) U.S. Cl. CPC G06T 5/92; G06T 5/60; G06T 5/70; G06T 2207/20081; G06T 2207/20084; G06T 2207/20208

(57) ABSTRACT

The disclosed computer-implemented method may include receiving, by a computing device, an original video to relight. Additionally, the method may include predicting, by the computing device using a de-lighting model trained on a hybrid dataset of lighting-rich data and motion-rich data, an albedo video corresponding to the original video. The method may also include generating, by the computing device using a relighting model trained on the hybrid dataset, a relit video based on the albedo video under a specified lighting condition based on an input high dynamic range (HDR) map. Various other methods, systems, and computer-readable media are also disclosed.

### CROSS REFERENCE TO RELATED APPLICATION

This application claims the benefit of U.S. Provisional Application No. 63/720,688, filed 14 Nov. 2024, the disclosure of which is incorporated, in its entirety, by this reference.

### BACKGROUND

For digital media applications, digital representations of human faces are becoming increasingly prominent in contexts such as film, video games, and virtual reality. For example, content creators may want to relight captured video to depict particular moods or to better represent an artistic vision. However, for more control over specific lighting conditions, it can be difficult and expensive to realistically relight portraits, particularly for post-production videos. In many instances, capturing the full nuance of facial appearance, including subtle shading, highlights, and textural details, is important for integration into diverse digital environments. Traditionally, facial performances have been recorded under a single, uniform lighting condition, which limits the flexibility required to generate varied, high-quality renderings. For example, light stages can use arrays of inward-pointing cameras to record dynamic human performances. However, this is generally captured under flat lighting, which limits lighting effects and integration of human models into new environments. Additionally, such methods are often limited to relighting known subjects, and these methods can be inaccurate for fine-grain lighting control of novel subjects. Furthermore, a large variety of data may be required to train models to relight arbitrary portrait videos, ideally with paired videos under different lighting conditions, which can be difficult and expensive to obtain.

To bypass light stage data, other techniques can train multi-illumination datasets to generalize relighting, such as by creating 3D representations. However, these techniques often struggle to maintain temporal consistency when applied to videos, creating a tradeoff between spatial quality and temporal consistency. For example, some methods apply temporal smoothing that leads to blurry shading and averaged details, thereby decreasing image quality. Other methods that improve image quality, such as image diffusion models that use harmonization methods to adjust foregrounds to match backgrounds, are often not temporally stable. Thus, better methods of facial performance relighting are needed to provide robust, scalable techniques that provide precise lighting control while maintaining temporal consistency.

### SUMMARY

As will be described in greater detail below, the present disclosure describes systems and methods for conditional video diffusion relighting. In one example, a computer-implemented method for conditional video diffusion relighting may include receiving, by a computing device, an original video to relight. The method may also include predicting, by the computing device using a de-lighting model trained on a hybrid dataset of lighting-rich data and motion-rich data, an albedo video corresponding to the original video. In addition, the method may include generating, by the computing device using a relighting model trained on the hybrid dataset, a relit video based on the albedo video under a specified lighting condition based on an input high dynamic range (HDR) map.

In one embodiment, the lighting-rich data includes a set of lit videos comprising synthetic videos derived from applying camera effects to a set of one-light-at-a-time (OLAT) images, a set of corresponding albedo videos comprising synthetic videos derived from applying camera effects to a set of flat-lit images corresponding to the set of OLAT images, and a set of environment HDR maps randomly paired with the set of lit videos. In this embodiment, the set of lit videos further includes synthetic videos derived from relit versions of the set of OLAT images using an image-based relighting model, wherein the set of environment HDR maps is randomly paired with the set of lit videos to create the relit versions.

In one example, the motion-rich data includes a set of lit videos comprising in-the-wild videos with diverse motion patterns and diverse lighting and a set of corresponding albedo videos comprising pseudo-albedo videos derived from the set of lit videos using an image-based de-lighting model for each frame of each lit video.

In some embodiments, the de-lighting model is trained by initializing the de-lighting model with a pre-trained video diffusion model, performing a first-stage training on short segments of videos to tune model weights, and performing a second-stage training on longer segments of videos over a number of iterations.

In some examples, the de-lighting model is trained by, for the lighting-rich data, comparing de-lighting results of lit videos to corresponding albedo videos. In these examples, the de-lighting model is also trained by, for the motion-rich data, comparing the de-lighting results of lit videos to corresponding pseudo-albedo videos. In these examples, comparing the de-lighting results of lit videos to the corresponding pseudo-albedo videos further includes using reference-based conditioning on the de-lighting model by performing reference-based appearance copy to align frames of a resulting pseudo-albedo video with a reference de-lit frame.

In one example, the relighting model is trained by initializing the relighting model with a pre-trained video diffusion model, performing a first-stage training on short segments of videos to tune model weights. and performing a second-stage training on longer segments of videos over a number of iterations.

In one embodiment, the relighting model is trained by, for the lighting-rich data, comparing relighting results of albedo videos to corresponding lit videos. In this embodiment, the relighting model is trained by, for the motion-rich data, comparing the relighting results of pseudo-albedo videos to corresponding lit videos. In this embodiment, comparing the relighting results of the pseudo-albedo videos to the corresponding lit videos further includes using reference-based conditioning on the relighting model by performing reference-based appearance copy to align frames of a resulting lit video with a reference lit frame. In this embodiment, comparing the relighting results of the albedo videos to the corresponding lit videos further includes using reference-based conditioning and/or using HDR-based conditioning with an environment HDR map.

In some embodiments, the de-lighting model and the relighting model are trained by performing an iterative process to generate subsequent frames based on previous predictions, wherein a step of the iterative process replaces a number of initial frames of a video segment with the previous predictions, updates masks for the number of initial frames, and predicts remaining frames of the video segment.

In some examples, generating the relit video includes (1) encoding the input HDR map as light embeddings, (2) deriving and concatenating input latents, binary masks, and noise latents over time for the albedo video, (3) inputting the light embeddings and the concatenation to a denoising neural network trained to predict noise to reconstruct videos by minimizing mean squared error between noise predictions and ground truth using specialized layers operating in latent space, (4) deriving relit latents from the denoising neural network, and (5) constructing the relit video using the relit latents. In these examples, encoding the input HDR map as light embeddings includes tokenizing images of the input HDR map by predicting directional lighting, encoding the tokenized images as light embeddings using a multilayer perceptron (MLP) and concatenating with positional encodings representing each light's average direction, wherein each light embedding represents a single directional light source, and inputting the light embeddings to the denoising neural network through cross-attention layers. In these examples, the input latents include latents of the albedo video and/or latents of relit frames of previous predictions.

In addition, a corresponding system for conditional video diffusion relighting may include several modules stored in memory, including a reception module that receives, by a computing device, an original video to relight. The system may also include a de-lighting module that predicts, by the computing device using a de-lighting model trained on a hybrid dataset of lighting-rich data and motion-rich data, an albedo video corresponding to the original video. In addition, the system may include a relighting module that generates, by the computing device using a relighting model trained on the hybrid dataset, a relit video based on the albedo video under a specified lighting condition based on an input HDR map. Finally, the system may include one or more processors that execute the reception module, the de-lighting module, and the relighting module.

In one embodiment, the lighting-rich data includes a set of lit videos comprising synthetic videos derived from applying camera effects to a set of OLAT images, a set of corresponding albedo videos comprising synthetic videos derived from applying camera effects to a set of flat-lit images corresponding to the set of OLAT images, and a set of environment HDR maps randomly paired with the set of lit videos.

In one example, the motion-rich data includes a set of lit videos comprising in-the-wild videos with diverse motion patterns and diverse lighting and a set of corresponding albedo videos comprising pseudo-albedo videos derived from the set of lit videos using an image-based de-lighting model for each frame of each lit video.

In some embodiments, the relighting module generates the relit video by (1) encoding the input HDR map as light embeddings, (2) deriving and concatenating input latents, binary masks, and noise latents over time for the albedo video, (3) inputting the light embeddings and the concatenation to a denoising neural network trained to predict noise to reconstruct videos by minimizing mean squared error between noise predictions and ground truth using specialized layers operating in latent space, (4) deriving relit latents from the denoising neural network, and (5) constructing the relit video using the relit latents.

In some examples, the above-described method may be encoded as computer-readable instructions on a non-transitory computer-readable medium. For example, a computer-readable medium may include one or more computer-executable instructions that, when executed by at least one processor of a computing device, such as a server, may cause the computing device to receive an original video to relight. The instructions may also cause the computing device to predict, using a de-lighting model trained on a hybrid dataset of lighting-rich data and motion-rich data, an albedo video corresponding to the original video. In addition, the instructions may cause the computing device to generate, using a relighting model trained on the hybrid dataset, a relit video based on the albedo video under a specified lighting condition based on an input HDR map.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for conditional video diffusion relighting.

FIG. 2 is a block diagram of an exemplary computing system for conditional video diffusion relighting.

FIG. 3 is a block diagram of an exemplary hybrid dataset for training conditional video diffusion relighting.

FIG. 4 is a block diagram of an exemplary de-lighting model trained using the hybrid dataset.

FIG. 5 is a block diagram of an exemplary relighting model trained using the hybrid dataset.

FIG. 6 is a block diagram of an exemplary relighting process.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to conditional video diffusion relighting for portrait videos. As will be explained in greater detail below, embodiments of the present disclosure may, by combining a conditional video diffusion model built upon a pretrained video diffusion model and a lighting injection mechanism, create a diffusion-based relighting model to produce high-quality relighting of arbitrary portrait videos with precise control. Specifically, the disclosed systems and methods first obtain a hybrid dataset of static expression one-light-at-a-time (OLAT) data and in-the-wild portrait performance videos to jointly learn relighting and temporal modeling. For example, an OLAT dataset can synthetically create different image pairs of the same person lit in hundreds of lighting conditions, while in-the-wild video datasets without paired lighting can include different people lit in different environments to train for temporal consistency of models. Additionally, the systems and methods described herein can synthetically create videos from static OLAT images by applying various effects, such as by imitating camera effects.

In some examples, the disclosed systems and methods may train a diffusion-based de-lighting model using the hybrid data. In this example, the systems and methods described herein can use a pretrained image de-lighting model on individual frames of in-the-wild videos to create pseudo-albedo videos that are de-lit similarly to flat-lit videos in OLAT data. The disclosed systems and methods can similarly train a diffusion-based relighting model with a combination of the hybrid data as well as collected high dynamic range (HDR) maps that provide environment lighting information. For example, the systems and methods described herein can randomly pair HDR maps with flat-lit, shading-free albedo videos to produce a variety of lighting environments and effects. In this example, the systems and methods described herein can determine specific lighting conditions from the hybrid dataset and create additional training data by relighting OLAT data with the collected HDR maps. Thus, the OLAT data enables the disclosed systems and methods to train the de-lighting and relighting models to identify and replicate various lighting conditions. By training the de-lighting and relighting models on the in-the-wild videos, the disclosed systems and methods also ensure temporal consistency that exists in natural clips is replicated in de-lighting and relighting videos. In addition, a process to condition the models for reference-based appearance copy, which aligns the lighting of frames of a video with a reference frame, can improve the temporal consistency particularly for generated pseudo-albedo videos. The trained de-lighting model is then used to create a de-lit albedo video from a given video that is to be relit. Furthermore, the trained relighting model can use an input HDR map to determine preferred lighting conditions and relight the albedo video based on those lighting conditions. By converting the input HDR map into light embeddings through tokenization and feeding both the embeddings and input latents of the albedo video into a denoising neural network, the systems and methods described herein can accurately reconstruct the video with the preferred lighting conditions.

The systems and methods described herein may improve the functioning of a computing device by reducing hardware requirements and increasing robustness of dynamic digital video relighting. The systems and methods described herein can then enable efficient hardware utilization and scalability for large datasets, supporting real-time or near-real-time dynamic applications such as relighting virtual and augmented reality avatars. For example, by training the model using iterative processes for videos of arbitrary length, the disclosed systems and methods enable continuous relighting of videos that maintains consistency with previously relit video segments while reducing processing and memory requirements by only using a number of previous relit frames to condition current relighting. By training the models on sufficiently large hybrid datasets of lighting-rich and motion-rich videos, the disclosed systems and methods also enable relighting of new subjects not previously trained on the models, thereby reducing processing requirements for novel subjects. In addition, these systems and methods may improve the fields of image processing and digital content creation by maintaining quality and consistency in relit images and videos. For example, diffusion models can generate high-quality images by sampling from a learned distribution of natural images, particularly when conditioned on environment HDR maps, thereby improving photorealistic lighting. As another example, by creating tokenized lighting embeddings based on HDR mapping, the systems and methods described herein improve encoding of lighting information and enable precise lighting control. Thus, the disclosed systems and methods may improve over traditional methods of relighting videos by enabling post-production relighting without a need for expensive equipment or training.

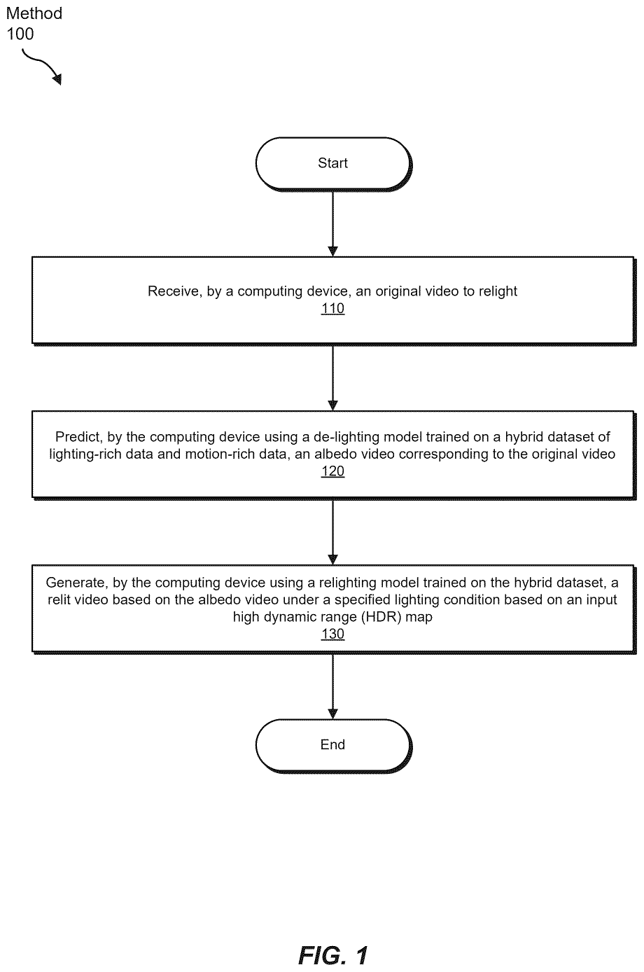

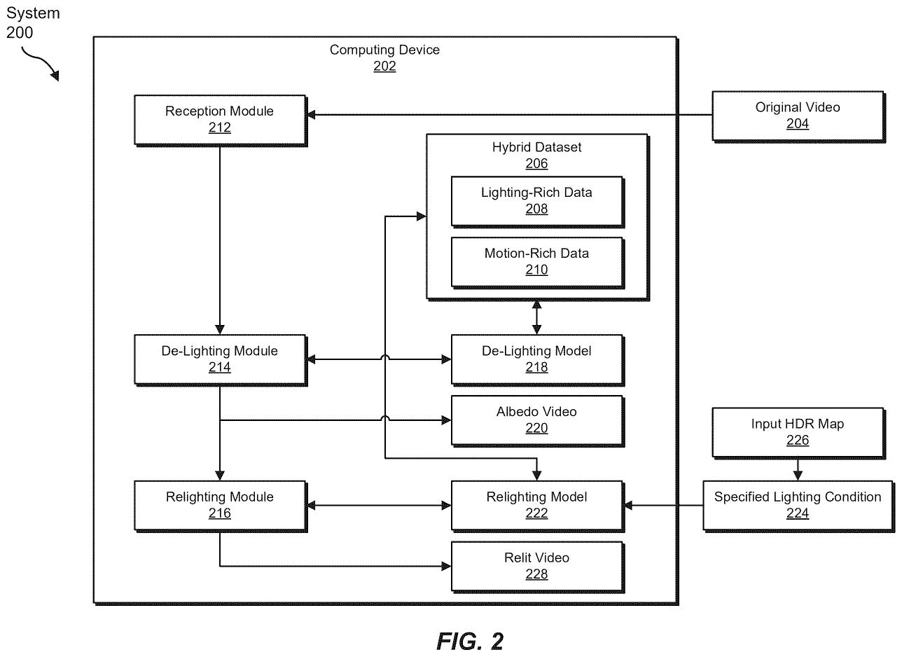

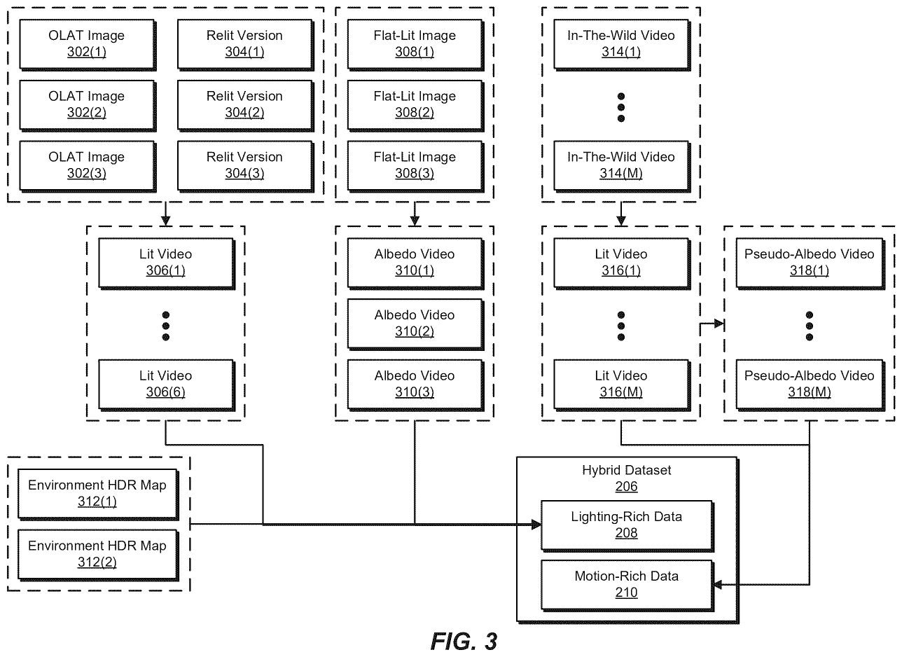

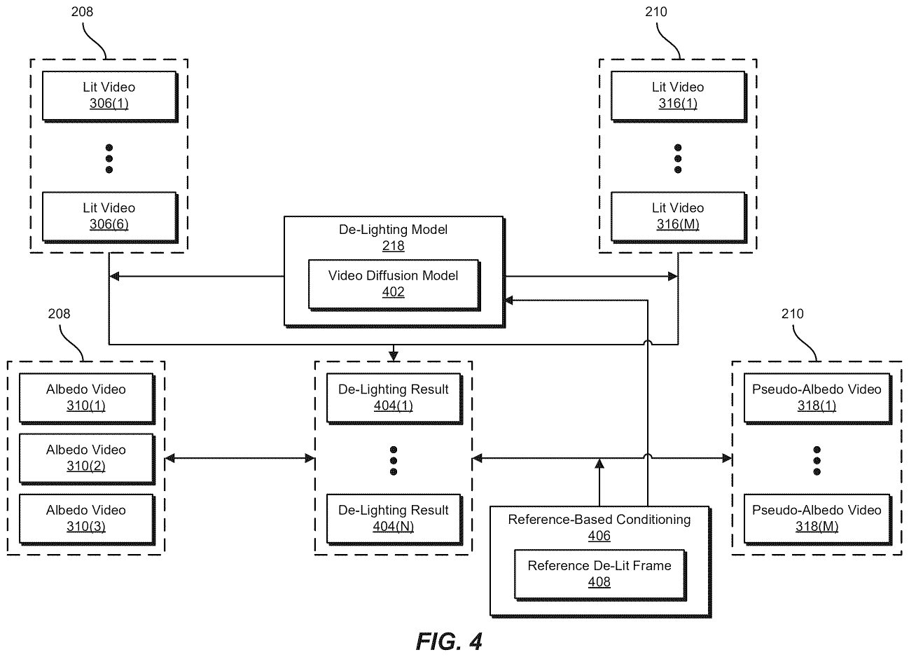

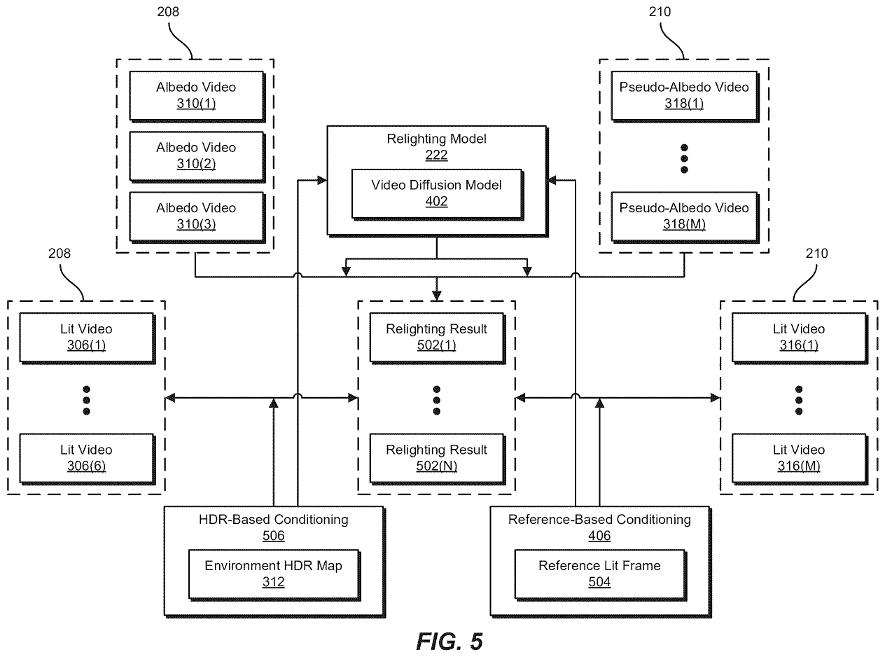

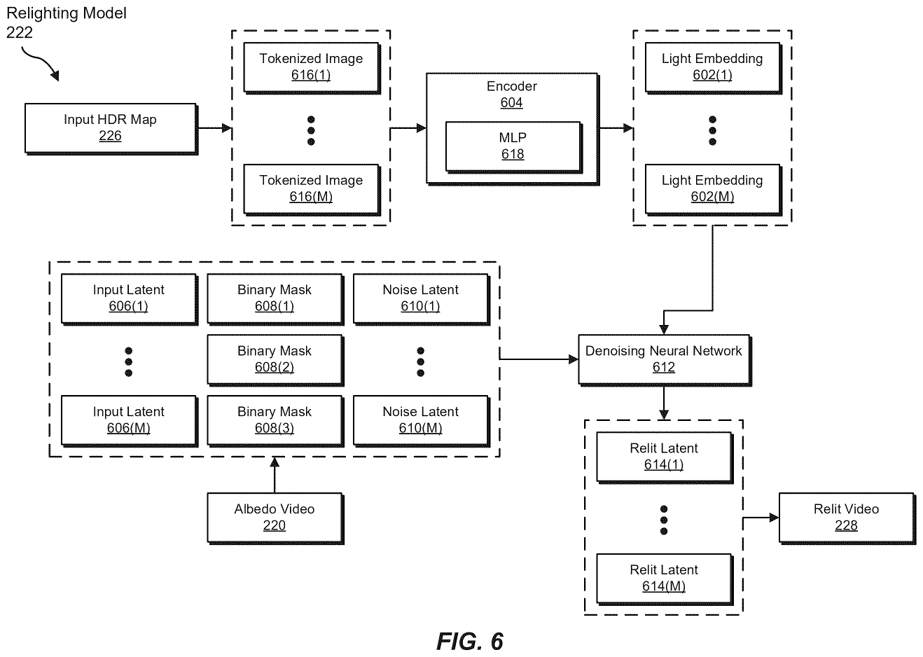

Thereafter, the description will provide, with reference to FIG. 1, detailed descriptions of computer-implemented methods for conditional video diffusion relighting. Detailed descriptions of a corresponding exemplary computing system will be provided in connection with FIG. 2. Detailed descriptions of an exemplary hybrid dataset for training conditional video diffusion relighting will be provided in connection with FIG. 3. In addition, detailed descriptions of an exemplary de-lighting model trained using the hybrid dataset will be provided in connection with FIG. 4. Detailed descriptions of an exemplary relighting model trained using the hybrid dataset will be provided in connection with FIG. 5. Furthermore, detailed descriptions of an exemplary relighting process will be provided in connection with FIG. 6.

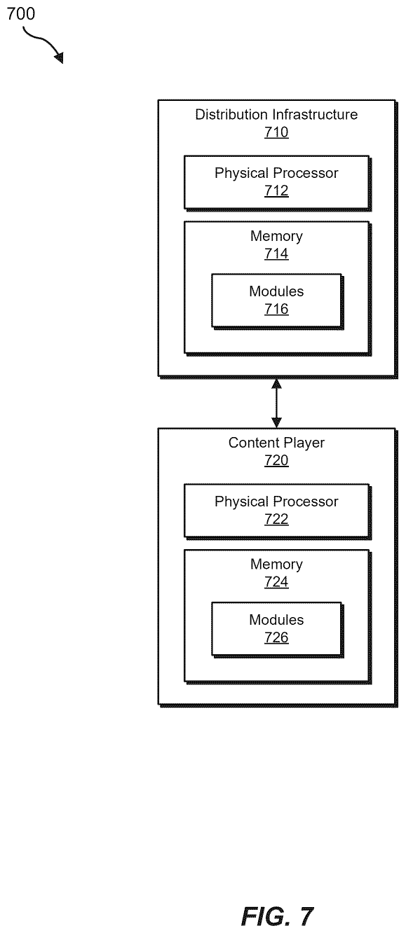

Because many of the embodiments described herein may be used with substantially any type of computing network, including distributed networks designed to provide video content to a worldwide audience, various computer network and video distribution systems will initially be described with reference to FIGS. 7-9. These figures will introduce the various networks and distribution methods used to provision video content to users.

FIG. 1 is a flow diagram of an exemplary computer-implemented method 100 for video relighting. The steps shown in FIG. 1 may be performed by any suitable computer-executable code and/or computing system, including the systems illustrated in FIGS. 7-9, computing device 202 in FIG. 2, or a combination of one or more of the same. In one example, each of the steps shown in FIG. 1 may represent an algorithm whose structure includes and/or is represented by multiple sub-steps, examples of which will be provided in greater detail below. In some examples, all of the steps and sub-steps represented in FIG. 1 may be performed by one device (e.g., either a server or a client computing device). Alternatively, the steps and/or substeps represented in FIG. 1 may be performed across multiples devices (e.g., some of steps and/or sub-steps may be performed by a server and other steps and/or sub-steps may be performed by a client computing device).

As illustrated in FIG. 1, at step 110, one or more of the systems described herein may receive, by a computing device, an original video to relight. For example, FIG. 2 is a block diagram of an exemplary system 200 for conditional video diffusion relighting. As illustrated in FIG. 2, a reception module 212 may, as part of a computing device 202, receive an original video 204 to relight.

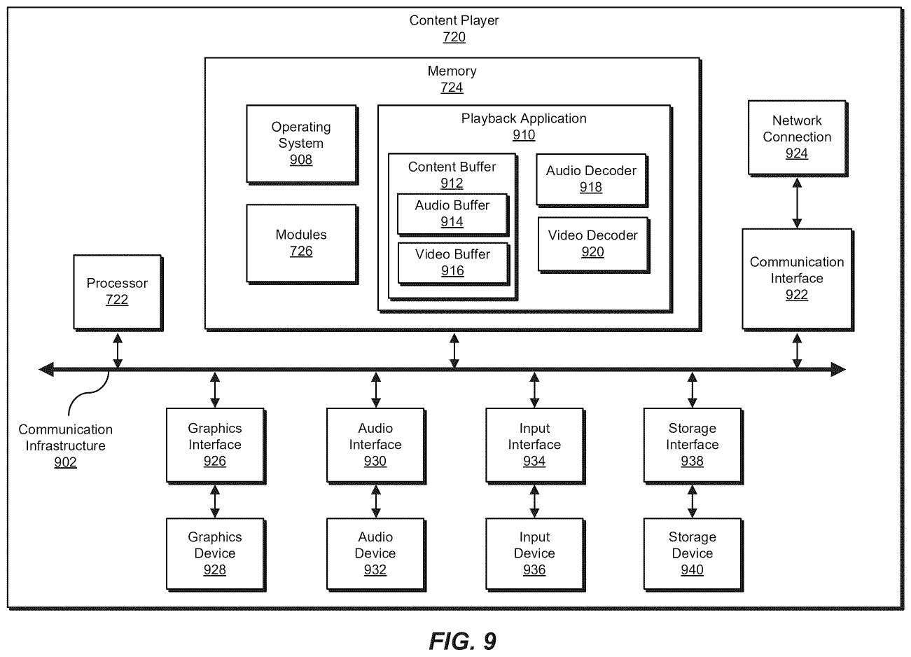

In some embodiments, computing device 202 may generally represent any type or form of computing device capable of running computing software and applications to perform conditional video diffusion relighting. As used herein, the term “application” generally refers to a software program designed to perform specific functions or tasks and capable of being installed, deployed, executed, and/or otherwise implemented on a computing system. Examples of applications may include, without limitation, playback application 910 of FIG. 9, productivity software, enterprise software, entertainment software, security applications, cloud-based applications, web applications, mobile applications, content access software, simulation software, integrated software, application packages, application suites, variations or combinations of one or more of the same, and/or any other suitable software application. Examples of client devices may include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Additionally, client devices may include content player 720 in FIGS. 7 and 9 and/or various other components of FIGS. 7-9.

In other embodiments, computing device 202 may generally represent a server capable of processing user and/or client device requests to perform conditional video diffusion relighting. Computing device 202 may alternatively generally represent any type or form of server that is capable of storing and/or managing content and user data, such as videos for a video hosting platform. Examples of a server include, without limitation, security servers, application servers, web servers, storage servers, streaming servers, and/or database servers configured to run certain software applications and/or to provide various security, web, storage, streaming, and/or database services. Additionally, computing device 202 may include distribution infrastructure 710 and/or various other components of FIGS. 7-9.

Although illustrated as part of computing device 202 in FIG. 2, some or all of the modules described herein may alternatively be executed by a separate server or any other suitable computing device. For example, computing device 202 may represent a front-end device for conditional video diffusion relighting or, alternatively, may represent part of system 200 for backend conditional video diffusion relighting. As another example, computing device 202 may represent an endpoint device or multiple endpoint devices that service client devices. For example, system 200 may include multiple servers and/or computing devices that include computing device 202, databases hosting a variety of data and backend services, and/or any other suitable device or combination of devices.

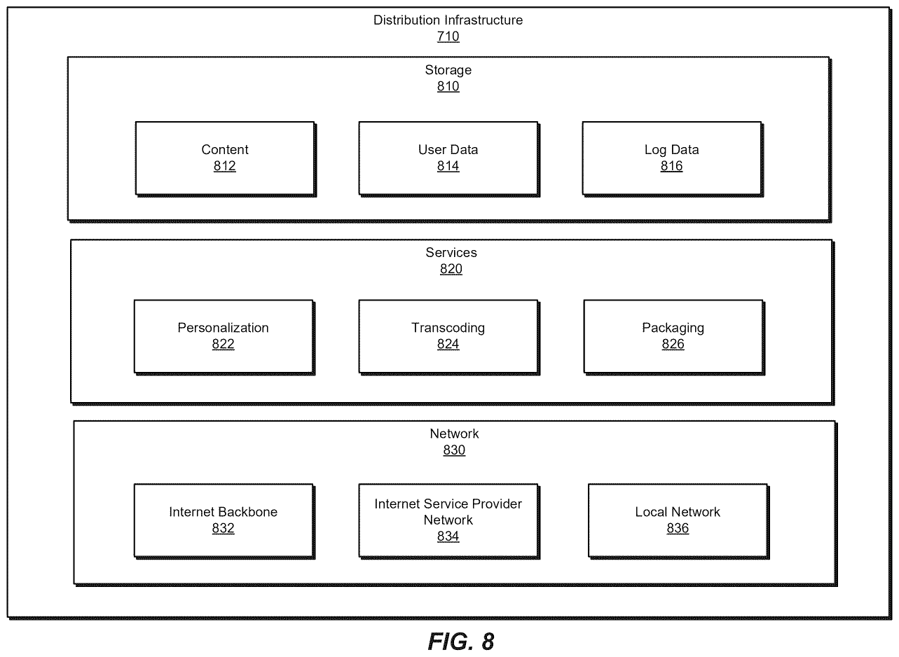

In the above embodiments, computing device 202 may be directly in communication with other servers and/or in communication with other computing devices via a network. In some examples, the term “network” may refer to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 830 of FIG. 8, or any other suitable network. For example, a network may facilitate data transfer between computing device 202 and other devices using wireless or wired connections.

The systems described herein may perform step 110 in a variety of ways. In some embodiments, a user of system 200 may send original video 204 to be relit by computing device 202. In these examples, the user may additionally send an input HDR map 226 to specify lighting conditions under which to relight original video 204. In other examples, system 200 may provide a graphic user interface (GUI) that enables the user to select from a menu of lighting options for which associated input HDR maps are pre-generated. In these examples, original video 204 and/or input HDR map 226 may be stored on computing device 202. In further examples, original video 204 may be transmitted to computing device 202, such as through a network from a client device.

As used herein, the term “de-lighting” generally refers to a process for generating new visual content that is similar to an original content with the exception of creating a new flat-lit rendering of the original content. In one example, the term “flat-lit rendering” may refer to a method of generating an image with a goal of minimal shading and shadows. Similarly, the term “relighting” generally refers to a process for generating new visual content that is similar to an original content with the exception of an environmental lighting rendering. In some examples, the term “high dynamic range” generally refers to a method to capture or represent images with a wide range of brightness and color levels, particularly for high contrast details. In these examples, the term “HDR map” generally refers to a mapping of the wide range of levels to create a digital environment with lighting information. In these example, HDR maps can contain information about lighting size, intensity, direction, diffusion, and/or other attributes that dictate how a subject should be lit when added to the environment of each HDR map.

Returning to FIG. 1, at step 120, one or more of the systems described herein may predict, by the computing device using a de-lighting model trained on a hybrid dataset of lighting-rich data and motion-rich data, an albedo video corresponding to the original video. For example, a de-lighting module 214 may, as part of computing device 202 in FIG. 2, predict an albedo video 220 corresponding to original video 204 using a de-lighting model 218 trained on a hybrid dataset 206 of lighting-rich data 208 and motion-rich data 210.

The systems described herein may perform step 120 in a variety of ways. In some examples, the term “albedo” refers to a measurement for light reflection of different surfaces. As used herein, the term “albedo video” generally refers to a video with reduced shading and shadows to provide a flat appearance of a subject's surfaces while maintaining basic attributes. In some examples, hybrid dataset 206 may be stored on computing device 202 and/or another device as part of system 200. In other examples, part or all of hybrid dataset 206 may be obtain through outside sources and/or provided by a user or administrator of system 200.

In some embodiments, lighting-rich data 208 includes a set of lit videos comprising synthetic videos derived from applying camera effects to a set of one-light-at-a-time (OLAT) images. The term “one-light-at-a-time” generally refers to a method of capturing image or video data with a single light source illuminated at any given point in time. In these embodiments, lighting-rich data 208 also includes a set of corresponding albedo videos comprising synthetic videos derived from applying camera effects to a set of flat-lit images corresponding to the set of OLAT images. Additionally, lighting-rich data 208 includes a set of environment HDR maps randomly paired with the set of lit videos. In these examples, the set of lit videos further includes synthetic videos derived from relit versions of the set of OLAT images using an image-based relighting model, wherein the set of environment HDR maps is randomly paired with the set of lit videos to create the relit versions.

In some examples, motion-rich data 210 includes a set of lit videos comprising in-the-wild videos with diverse motion patterns and diverse lighting. In these examples, motion-rich data 210 also includes a set of corresponding albedo videos comprising pseudo-albedo videos derived from the set of lit videos using an image-based de-lighting model for each frame of each lit video.

As illustrated in FIG. 3, a set of OLAT images 302(1)-(3) may correspond to a set of flat-lit images 308(1)-(3). In this example, OLAT images 302(1)-(3) can be captured through a method such as a light stage with a set of LED panels that turn one LED light on at a time and a set of cameras to capture a subject lit by the LED lights. In this example, paired flat-lit images 308(1)-(3) can similarly be captured by the light stage but with all LED lights turned on to approximate diffuse albedo lighting. In this example, the light stage can capture images from different angles using different cameras, and a number of subjects can be captured under different light directions. Although illustrated as corresponding sets of three images, OLAT images 302(1)-(3) and flat-lit images 308(1)-(3) can represent multiple additional images, such as a multitude of images for a multitude of subjects, poses, expressions, angles, and/or lighting conditions. Additionally, a pretrained image-based relighting model can be applied to OLAT images 302(1)-(3) and/or flat-lit images 308(1)-(3) to create variations of lighting that were not originally captured for the same subject and positions or expression. In the example of FIG. 3, the results can become relit versions 304(1)-(3). In this example, relit versions 304(1)-(3) can be derived from applying lighting conditions from environment HDR maps 312(1)-(2) to individual images. For example, HDR map 312(1) may include a two-dimensional panoramic image of an environment represented as a map, with lighting information determined for each direction. By generating relit versions of original images using randomly selected environment HDR maps, computing device 202 can create a more robust dataset for lighting-rich data 208. In other examples, additional versions can be created for more robust training data, such as multiple relit versions of each original OLAT image or flat-lit image. In various examples, pairs of OLAT and flat-lit images and/or environment HDR maps can be retrieved from a local storage, a remote storage, and/or collected from other sources. For example, the image pairs can be captured by the light stage and transmitted to system 200.

Because OLAT images 302(1)-(3), relit versions 304(1)-(3), and flat-lit images 308(1)-(3) are static images, a synthesizing process is needed to generate videos based on these images. For example, lit videos 306(1)-(6) of FIG. 3 are derived from OLAT images 302(1)-(3) and relit versions 304(1)-(3). Similarly, albedo videos 310(1)-(3) are derived from flat-lit images 308(1)-(3) that correspond to sets of OLAT and relit images. In the example of FIG. 3, videos are derived by applying camera effects to static images. For example, camera effects like cropping, zooming, and/or panning can be applied to create videos with subjects that do not move but pixels that change from frame to frame. Thus, lighting-rich data 208 includes lit videos 306(1)-(6), corresponding albedo videos 310(1)-(3), and environment HDR maps 312(1)-(2).

As illustrated in FIG. 3, a set of in-the-wild videos 314(1)-(M) may represent a set of lit videos 316(1)-(M). In this example, each in-the-wild video can be directly used as a lit video. In other examples, each in-the-wild video can be parsed into multiple lit videos for a more robust dataset. In the example of FIG. 3, lit videos 316(1)-(M) typically do not include notations for lighting conditions, as lit videos 306(1)-(6) can include. Instead, lit videos 316(1)-(M) may include a range of videos with high-quality talking heads with diverse motion patterns. Additionally, an image-based de-lighting model can be trained, such as by using paired OLAT images and flat-lit images, to create flat-lit images from lit images. In the example of FIG. 3, the image-based de-lighting model is used to transform each of lit videos 316(1)-(M), frame by frame, into frames of pseudo-albedo videos 318(1)-(M). In this example, the image-based de-lighting model may use a frame as a reference to attempt to copy the lighting of the reference image to frames of videos. In the de-lighting example, the model can use a flat-lit image as a reference to transform frames of lit videos 316(1)-(M) to flat lighting. Thus, as shown in FIG. 3, motion-rich data 210 includes lit videos 316(1)-(M) derived from in-the-wild videos 314(1)-(M) and pseudo-albedo videos 318(1)-(2) derived from lit videos 316(1)-(M). In this example, because de-lighting reduces shading and shadows, environment HDR maps are not needed for preprocessing motion-rich data 210, which may not include lighting notations.

In the above embodiments, enough initial data is collected for hybrid dataset 206 to train a relighting model that can be generalized to relighting new subjects or people. In these embodiments, hybrid dataset 206 can include a predetermined number of subjects captured for paired OLAT and flat-lit images for in-depth lighting conditioning. In these embodiments, hybrid dataset 206 can also include a large number of in-the-wild videos for a large variety of motions, such as expression changes and subject movement, and a large variety of lighting conditions. In other words, lighting-rich data 208 includes synthetically generated lit pseudo-videos without original motion but with ground truth lighting, while motion-rich data 210 includes generated pseudo-albedo videos without original ground truth but with motion.

In one embodiment, de-lighting model 218 is trained by initializing de-lighting model 218 with a pre-trained video diffusion model, performing a first-stage training on short segments of videos to tune model weights, and performing a second-stage training on longer segments of videos over a number of iterations. In this embodiment, de-lighting model 218 can be quickly trained and subsequently fine-tuned while leveraging existing video diffusion model capabilities.

In one example, de-lighting model 218 is trained by, for lighting-rich data 208, comparing de-lighting results of lit videos to corresponding albedo videos and, for motion-rich data 210, comparing the de-lighting results of lit videos to corresponding pseudo-albedo videos. In this example, comparing the de-lighting results of lit videos to the corresponding pseudo-albedo videos can further include using reference-based conditioning on de-lighting model 218 by performing reference-based appearance copy to align frames of a resulting pseudo-albedo video with a reference de-lit frame. Furthermore, de-lighting model 218 is trained by performing an iterative process to generate subsequent frames based on previous predictions, wherein a step of the iterative process replaces a number of initial frames of a video segment with the previous predictions, updates masks for the number of initial frames, and predicts remaining frames of the video segment. During training, de-lighting model 218 can randomly sample the initial frames and replace input frames with ground truth data. By performing the iterative process, de-lighting model 218 can process long or ongoing videos while maintaining temporal consistency between frames or segments of video. For example, rather than only taking original video 204 as input, de-lighting model 218 can also take previously de-lit frames as input for de-lighting segments of a video over time. In this example, binary masks can be used to distinguish between original video 204 input frames and previous predictions of de-lit frames. Thus, de-lighting module 214 can predict de-lit versions of original video 204 for videos without a fixed length, such as livestreaming videos.

As illustrated in FIG. 4, de-lighting model 218 can be built on a video diffusion model 402 to de-light videos, effectively modifying video diffusion model 402 to become a conditional generator. In this example, de-lighting model 218 can be trained to de-light lit videos 306(1)-(6) from lighting-rich data 208 and lit videos 316(1)-(M) from motion-rich data 210 to create de-lighting results 404(1)-(N). In this example, albedo videos 310(1)-(3) from lighting-rich data 208 can be compared to corresponding de-lighting results 404(1)-(N) to determine the accuracy of de-lighting model 218, which can be adjusted and iteratively retrained to improve de-lighting. Similarly, pseudo-albedo videos 318(1)-(M) can be compared to corresponding de-lighting results 404(1)-(N). However, since pseudo-albedo videos 318(1)-(M) are generated by system 200, reference-based conditioning 406 can be performed using a reference de-lit frame 408 to ensure de-lighting model 218 accurately replicates the de-lit appearance of reference de-lit frame 408 for pseudo-albedo videos 318(1)-(M) corresponding to lit videos 316(1)-(M) when generating de-lighting results 404(1)-(N). In other examples, reference-based conditioning 406 can similarly be applied to de-lighting lit videos 306(1)-(6). In the above examples, reference de-lit frame 408 can be a single frame from a reference video, a previously de-lit frame from a prior segment of a video, and/or any other appropriate reference to train de-lighting model 218 to ensure albedo frame consistency over time. By performing reference-based conditioning 406, computing device 202 can reduce temporal errors from the lack of lighting condition notations of in-the-wild videos.

Returning to FIG. 1, at step 130, one or more of the systems described herein may generate, by the computing device using a relighting model trained on the hybrid dataset, a relit video based on the albedo video under a specified lighting condition based on an input HDR map. For example, a relighting module 216 may, as part of computing device 202 in FIG. 2, generate, using a relighting model 222 trained on hybrid dataset 206, a relit video 228 based on albedo video 220 under a specified lighting condition 224 based on input HDR map 226.

The systems described herein may perform step 130 in a variety of ways. In one embodiment, similar to training de-lighting model 218, relighting model 222 is trained by initializing relighting model 222 with a pre-trained video diffusion model, performing a first-stage training on short segments of videos to tune model weights, and performing a second-stage training on longer segments of videos over a number of iterations. The two-stage training process enables faster convergence for the model to quickly tune to relighting videos while also optimizing temporal layers over the longer stage.

Also similar to training de-lighting model 218, relighting model 222 is trained by performing an iterative process to generate subsequent frames based on previous predictions, wherein a step of the iterative process replaces a number of initial frames of a video segment with the previous predictions, updates masks for the number of initial frames, and predicts remaining frames of the video segment. In other words, relighting model 222 can also process long or ongoing videos while maintaining temporal consistency between frames or segments of video. For example, rather than only taking albedo video 220 as input, relighting model 222 can also take previously relit frames as input for relighting segments of a video over time. In this example, binary masks can be used to distinguish between albedo video 220 input frames and previous predictions of relit frames. Thus, relighting module 216 can predict relit versions of albedo video 220 for original videos without a fixed length, such as livestreaming videos.

In some examples, the architecture of relighting model 222 is similar but inverse to the architecture of de-lighting model 218. In these examples, both models are built on similar video diffusion models but differ in input and conditioning. Additionally, both models can be supervised during training to learn, respectively, relighting mapping and de-lighting mapping. However, the models are trained independently on hybrid dataset 206 and do not share weights or other attributes.

In some embodiments, relighting model 222 is trained by, for motion-rich data 210, comparing the relighting results of pseudo-albedo videos to corresponding lit videos. In these embodiments, comparing the relighting results of the pseudo-albedo videos to the corresponding lit videos further includes using reference-based conditioning on the relighting model by performing reference-based appearance copy to align frames of a resulting lit video with a reference lit frame. In these examples, the reference lit frame can be a frame from a reference lit video, a frame from a training video subsequence, and/or any other suitable reference frame used to train relighting model to copy a lighting condition. Because motion-rich data 210 lacks HDR maps needed to condition relighting, relighting model 222 is trained to perform reference-based appearance copy to condition relighting and to ensure temporal consistency of lighting over time.

In the above embodiments, relighting model 222 is also trained by, for lighting-rich data 208, comparing relighting results of albedo videos to corresponding lit videos. In these embodiments, comparing the relighting results of the albedo videos to the corresponding lit videos further includes using reference-based conditioning and/or using HDR-based conditioning with an environment HDR map. In other words, because lighting-rich data 208 includes lighting condition notations, relighting model 222 can train HDR-based relighting and reference-based appearance copy simultaneously. In some examples, videos from lighting-rich data 208 can be randomly conditioned on either HDR-based relighting, reference-based relighting, or both. In this way, lighting-rich data 208 can provide relighting supervision for individual frames, while motion-rich data 210 can produce temporally consistent performances. Thus, relighting model 222 can learn from both lighting-rich data 208 and motion-rich data 210 to combine accurate lighting control with improved temporal stability.

As illustrated in FIG. 5, relighting model 222 can be built on video diffusion model 402 to relight videos, effectively modifying video diffusion model 402 to become a conditional generator. In this example, relighting model 222 can be trained to relight albedo videos 310(1)-(3) from lighting-rich data 208 and pseudo-albedo videos 318(1)-(M) from motion-rich data 210 to create relighting results 502(1)-(N). In this example, lit videos 306(1)-(6) from lighting-rich data 208 can be compared to corresponding relighting results 502(1)-(N) to determine the accuracy of relighting model 222, which can be adjusted and iteratively retrained to improve relighting. Similarly, lit videos 316(1)-(M) can be compared to corresponding relighting results 502(1)-(N). However, since pseudo-albedo videos 318(1)-(M) are generated by system 200, reference-based conditioning 406 can be performed using a reference lit frame 504 to ensure relighting model 222 accurately replicates the lighting conditions of reference lit frame 504 for lit videos 316(1)-(M) corresponding to pseudo-albedo videos 318(1)-(M) when generating relighting results 502(1)-(N). In other examples, reference-based conditioning 406 can similarly be applied to relighting albedo videos 310(1)-(3). In the above examples, reference lit frame 504 can be a single frame from a reference video, a previously relit frame from a prior segment of a video, and/or any other appropriate reference to train relighting model 222 to ensure frame lighting consistency over time. By performing reference-based conditioning 406, computing device 202 can reduce temporal errors from the lack of lighting condition notations of in-the-wild videos. Meanwhile, HDR-based conditioning 506 can be performed using an environment HDR map 312 to ensure relighting model 222 accurately replicates the lighting conditions of environment HDR map 312 for lit videos 306(1)-(6) corresponding to albedo videos 310(1)-(3) when generating relighting results 502(1)-(N). In this example, relighting model 222 can directly take environment HDR map 312 as the lighting condition and attempt to recreate the lighting condition for relighting results 502(1)-(N). In other examples, reference-based conditioning 406 may be used in place of HDR-based conditioning 506 for lighting-rich data 208 and/or a combination of both reference-based conditioning 406 and HDR-based conditioning 506 may be used simultaneously.

In one embodiment, relighting module 216 generates relit video 228 by encoding input HDR map 226 as light embeddings and then deriving and concatenating input latents, binary masks, and noise latents over time for albedo video 220. The light embeddings effectively represent the lighting environment of the 2D image of input HDR map 226. In this embodiment, relighting module 216 then inputs the light embeddings and the concatenation to a denoising neural network trained to predict noise to reconstruct videos by minimizing mean squared error between noise predictions and ground truth using specialized layers operating in latent space. Subsequently, relighting module 216 derives relit latents from the denoising neural network and constructs relit video 228 using the relit latents.

As used herein, the term “encoding” generally refers to a process of converting data from one format to another format, such as an image format into a text representation. Similarly, the term “decoding” generally refers to a process of converting data from an encoded format back to an original format, such as the text representation back to the image format. The term “latent,” as used herein, generally refers to unobserved or hidden variables within a model where complex data is represented in an abstract form to create a mathematical space. The term “neural network,” as used herein, generally refers to a model of connected data that is weighted based on input data and used to estimate a function. For example, a convolutional neural network may use convolution and other machine learning techniques to modify a sequence in order to condense the size and complexity of the data and detect features within the data. In this example, a denoising neural network can use convolution and neural network layers for image segmentation and to predict noise within an image or video. As used herein, the term “machine learning” generally refers to a computational algorithm that may learn from data in order to make predictions. As used herein, the term “embedding” generally refers to a representation of data mapped to a vector space, such as images represented in text format.

In the above embodiment, relighting module 216 encodes input HDR map 226 as light embeddings by tokenizing images of input HDR map 226 by predicting directional lighting. In this embodiment, relighting module 216 then encodes the tokenized images as light embeddings using a multilayer perceptron (MLP) and concatenating with positional encodings representing each light's average direction, wherein each light embedding represents a single directional light source. As used herein, the term “multilayer perceptron” generally refers to a feed-forward neural network that includes multiple interconnected layers to handle linear data. The light embeddings can then be input to the denoising neural network through cross-attention layers. In some examples, the term “cross-attention” generally refers to a neural network method to enable a model to simultaneously focus on a first sequence while also processing a second sequence, thereby enabling interactions of the two sequences.

In the above embodiment, the input latents include latents of albedo video 220 and/or latents of relit frames of previous predictions, such as relit segments of original video 204 that occur before a current segment. Additionally, in the above embodiment, reference frames, such as reference de-lit frame 408 and reference lit frame 504, can be embedding using a convolutional neural network encoder to condition relighting model 222, thus creating a reference-based appearance copy mapping. The

As illustrated in FIG. 6, in the input HDR map 226 is transformed into tokenized images 616(1)-(M), which may then be encoded by an encoder 604 using an MLP 618 to create light embeddings 602(1)-(M). In this example, each of light embeddings 602(1)-(M) is computed by summing light intensities over a small local area in input HDR map 226 and represents a single directional light source, and the embeddings produce a complete lighting environment representation. In this example, tokens are then embedded into high-dimensional light embeddings 602(1)-(M). This representation is then passed to a diffusion model through cross-attention to achieve precise lighting control, specifically to a denoising neural network 612. To support both HDR-based conditioning 506 and reference-based conditioning 406, encoder 604 can be adapted for different inputs using masks. In the example of FIG. 6, albedo video 220 is used as input to derive input latents 606(1)-(M), binary masks 608(1)-(3) that distinguish between albedo frames and previously relit frames, and noise latents 610(1)-(M). These latents are then concatenated over time and used as input to denoising neural network to generate relit latents 614(1)-(M), while being conditioned by input HDR map 226 as a target lighting condition. In other examples, previously relit frames can be used as additional input to denoising neural network 612, such as by concatenating similar latents and noise for the previously relit frames. By using previous frames, relighting model 222 can predict subsequent frames of longer-sequence videos or videos without a set length.

In the example of FIG. 5, relighting model 222 is built on video diffusion model 402, which can use a forward pass that progressively injects Gaussian noise into video sequences and a reverse process with denoising neural network 612 that predicts the noise to reconstruct the videos without noise. In some examples, the term “Gaussian” generally refers to a mathematical function that describes a distribution of values. In particular, a Gaussian function, as used in graphics, refers to a function that smoothly spreads out from its center, creating a soft, blurry effect. In the above example, video diffusion model 402 can synthesize realistic and temporally coherent videos from text input. In this example, denoising neural network 612 can be trained by minimizing mean squared error between noise predictions and ground truth data. Additionally, denoising neural network 612 can include specialized layers, like three-dimensional convolution layers, cross-attention layers, self-attention layers, and/or temporal attention layers. In this example, denoising neural network 612 operates in latent space via a variational autoencoder (VAE) for efficiency. Furthermore, using multiple input channels to a first convolution layer of denoising neural network 612 to condition the denoising process on albedo video 220, relighting model 222 can adapt video diffusion model 402 for relighting with both lighting control and spatio-temporal conditioning.

In some embodiments, relighting model 222 can be extended to inference relighting for infinitely long videos by iteratively using previously relit frames in addition to current frames as input. In some embodiments, relighting model 222 can be used to relight single image portraits by treating them as short, static videos. In some embodiments, relighting model 222 can control directional light sources to condition alternate lighting attributes, such as diffuse lighting for softer shadows, based on preferences of a user. In other embodiments, de-lighting model 218 and relighting model 222 can be trained for any other suitable variations of de-lighting and relighting visual data.

As explained above in connection with method 100 in FIG. 1, the disclosed systems and methods, by expanding on lighting control and leveraging diffusion-based relighting models, can accurately reproduce complex lighting effects for arbitrary portrait videos under novel lighting conditions. Specifically, the disclosed systems and methods first collect hybrid data of a set of paired OLAT and flat-lit images with HDR mapping conditions as well as a set of in-the-wild real-world videos that provide a variety of positions, lighting conditions, and motions. By training both a de-lighting model and a relighting model on the hybrid data, the systems and methods described herein can combine the detailed lighting control of pair OLAT data and HDR mapping with the temporal consistency provided by a large amount of in-the-wild data. Additionally, the system and methods described herein can train the models to iteratively process videos over time, for arbitrary video lengths. The disclosed systems and methods may also train the models by using reference-based conditioning to compare lighting conditions with reference frames when HDR mapping is not available.

The disclosed systems and methods then use the trained models to de-light an input video to create an albedo video of flat-lit shading and, subsequently, relight the albedo video based on an input HDR map that dictates a target lighting condition. For example, the systems and methods described herein can tokenize the input HDR map to create light embeddings and use them to condition a denoising neural network to input albedo latents and output relit latents. In addition, the disclosed systems and methods can use previously relit frames as inputs to perform iterative prediction of a continuous video. Furthermore, by using HDR-based conditioning, reference-based conditioning, and/or a combination of the two, the disclosed systems and methods can enable high controllability for different lighting attributes. Thus, the systems and methods described herein may improve over traditional methods of dynamically relighting videos for more realistic lighting, color fidelity, and overall image quality.

Content that is created or modified using the methods described herein may be used and/or distributed in a variety of ways and/or by a variety of systems. Such systems may include content distribution ecosystems, as shown in FIGS. 7-9.

FIG. 7 is a block diagram of a content distribution ecosystem 700 that includes a distribution infrastructure 710 in communication with a content player 720. In some embodiments, distribution infrastructure 710 may be configured to encode data and to transfer the encoded data to content player 720 via data packets. Content player 720 may be configured to receive the encoded data via distribution infrastructure 710 and to decode the data for playback to a user. The data provided by distribution infrastructure 710 may include audio, video, text, images, animations, interactive content, haptic data, virtual or augmented reality data, location data, gaming data, or any other type of data that may be provided via streaming.

Distribution infrastructure 710 generally represents any services, hardware, software, or other infrastructure components configured to deliver content to end users. For example, distribution infrastructure 710 may include content aggregation systems, media transcoding and packaging services, network components (e.g., network adapters), and/or a variety of other types of hardware and software. Distribution infrastructure 710 may be implemented as a highly complex distribution system, a single media server or device, or anything in between. In some examples, regardless of size or complexity, distribution infrastructure 710 may include at least one physical processor 712 and at least one memory device 714. One or more modules 716 may be stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 may include a physical processor 722, memory 724, and one or more modules 726. Some or all of the adaptive streaming processes described herein may be performed or enabled by modules 726, and in some examples, modules 716 of distribution infrastructure 710 may coordinate with modules 726 of content player 720 to provide adaptive streaming of multimedia content.

In certain embodiments, one or more of modules 716 and/or 726 in FIG. 7 may represent one or more software applications or programs that, when executed by a computing device, may cause the computing device to perform one or more tasks. For example, and as will be described in greater detail below, one or more of modules 716 and 726 may represent modules stored and configured to run on one or more general-purpose computing devices. One or more of modules 716 and 726 in FIG. 7 may also represent all or portions of one or more special-purpose computers configured to perform one or more tasks.

Physical processors 712 and 722 generally represent any type or form of hardware-implemented processing unit capable of interpreting and/or executing computer-readable instructions. In one example, physical processors 712 and 722 may access and/or modify one or more of modules 716 and 726, respectively. Additionally or alternatively, physical processors 712 and 722 may execute one or more of modules 716 and 726 to facilitate adaptive streaming of multimedia content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 may store, load, and/or maintain one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 may include storage 810, services 820, and a network 830. Storage 810 generally represents any device, set of devices, and/or systems capable of storing content for delivery to end users. Storage 810 may include a central repository with devices capable of storing terabytes or petabytes of data and/or may include distributed storage systems (e.g., appliances that mirror or cache content at Internet interconnect locations to provide faster access to the mirrored content within certain regions). Storage 810 may also be configured in any other suitable manner.

As shown, storage 810 may store, among other items, content 812, user data 814, and/or log data 816. Content 812 may include television shows, movies, video games, user-generated content, and/or any other suitable type or form of content. User data 814 may include personally identifiable information (PII), payment information, preference settings, language and accessibility settings, and/or any other information associated with a particular user or content player. Log data 816 may include viewing history information, network throughput information, and/or any other metrics associated with a user's connection to or interactions with distribution infrastructure 710.

Services 820 may include personalization services 822, transcoding services 824, and/or packaging services 826. Personalization services 822 may personalize recommendations, content streams, and/or other aspects of a user's experience with distribution infrastructure 710. Encoding services, such as transcoding services 824, may compress media at different bitrates which may enable real-time switching between different encodings. Packaging services 826 may package encoded video before deploying it to a delivery network, such as network 830, for streaming.

Network 830 generally represents any medium or architecture capable of facilitating communication or data transfer. Network 830 may facilitate communication or data transfer via transport protocols using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 may include an Internet backbone 832, an internet service provider 834, and/or a local network 836.

FIG. 9 is a block diagram of an exemplary implementation of content player 720 of FIG. 7. Content player 720 generally represents any type or form of computing device capable of reading computer-executable instructions. Content player 720 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 may include a communication infrastructure 902 and a communication interface 922 coupled to a network connection 924. Content player 720 may also include a graphics interface 926 coupled to a graphics device 928, an audio interface 930 coupled to an audio device 932, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 may store and/or load an operating system 908 for execution by processor 722. In one example, operating system 908 may include and/or represent software that manages computer hardware and software resources and/or provides common services to computer programs and/or applications on content player 720.

Operating system 908 may perform various system management functions, such as managing hardware components (e.g., graphics interface 926, audio interface 930, input interface 934, and/or storage interface 938). Operating system 908 may also process memory management models for playback application 910. The modules of playback application 910 may include, for example, a content buffer 912, an audio decoder 918, and a video decoder 920.

Playback application 910 may be configured to retrieve digital content via communication interface 922 and play the digital content through graphics interface 926. A video decoder 920 may read units of video data from audio buffer 914 and/or video buffer 916 and may output the units of video data in a sequence of video frames corresponding in duration to the fixed span of playback time. Reading a unit of video data from video buffer 916 may effectively de-queue the unit of video data from video buffer 916. The sequence of video frames may then be rendered by graphics interface 926 and transmitted to graphics device 928 to be displayed to a user.

In situations where the bandwidth of distribution infrastructure 710 is limited and/or variable, playback application 910 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 720 may also include a storage device 940 coupled to communication infrastructure 902 via a storage interface 938. Storage device 940 generally represent any type or form of storage device or medium capable of storing data and/or other computer-readable instructions. For example, storage device 940 may be a magnetic disk drive, a solid-state drive, an optical disk drive, a flash drive, or the like. Storage interface 938 generally represents any type or form of interface or device for transferring data between storage device 940 and other components of content player 720.

Many other devices or subsystems may be included in or connected to content player 720. Conversely, one or more of the components and devices illustrated in FIG. 9 need not be present to practice the embodiments described and/or illustrated herein. The devices and subsystems referenced above may also be interconnected in different ways from that shown in FIG. 9. Content player 720 may also employ any number of software, firmware, and/or hardware configurations.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an image sequence to be transformed, transform the image sequence to create an albedo video, output a result of the transformation to a diffusion-based relighting model, use the result of the transformation to relight the image sequence, and store the result of the transformation to create a relit video. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a computing device, an original video to relight;
predicting, by the computing device using a de-lighting model trained on a hybrid dataset of lighting-rich data and motion-rich data, an albedo video corresponding to the original video; and
generating, by the computing device using a relighting model trained on the hybrid dataset, a relit video based on the albedo video under a specified lighting condition based on an input high dynamic range (HDR) map.

2. The method of claim 1, wherein the lighting-rich data comprises:
a set of lit videos comprising synthetic videos derived from applying camera effects to a set of one-light-at-a-time (OLAT) images;
a set of corresponding albedo videos comprising synthetic videos derived from applying camera effects to a set of flat-lit images corresponding to the set of OLAT images; and
a set of environment HDR maps randomly paired with the set of lit videos.

3. The method of claim 2, wherein the set of lit videos further comprises synthetic videos derived from relit versions of the set of OLAT images using an image-based relighting model, wherein the set of environment HDR maps is randomly paired with the set of lit videos to create the relit versions.

4. The method of claim 1, wherein the motion-rich data comprises:
a set of lit videos comprising in-the-wild videos with diverse motion patterns and diverse lighting; and
a set of corresponding albedo videos comprising pseudo-albedo videos derived from the set of lit videos using an image-based de-lighting model for each frame of each lit video.

5. The method of claim 1, wherein the de-lighting model is trained by:
initializing the de-lighting model with a pre-trained video diffusion model;
performing a first-stage training on short segments of videos to tune model weights; and
performing a second-stage training on longer segments of videos over a number of iterations.

6. The method of claim 1, wherein the de-lighting model is trained by:
for the lighting-rich data, comparing de-lighting results of lit videos to corresponding albedo videos; and
for the motion-rich data, comparing the de-lighting results of lit videos to corresponding pseudo-albedo videos.

7. The method of claim 6, wherein comparing the de-lighting results of lit videos to the corresponding pseudo-albedo videos further comprises using reference-based conditioning on the de-lighting model by performing reference-based appearance copy to align frames of a resulting pseudo-albedo video with a reference de-lit frame.

8. The method of claim 1, wherein the relighting model is trained by:
initializing the relighting model with a pre-trained video diffusion model;
performing a first-stage training on short segments of videos to tune model weights; and
performing a second-stage training on longer segments of videos over a number of iterations.

9. The method of claim 1, wherein the relighting model is trained by:
for the lighting-rich data, comparing relighting results of albedo videos to corresponding lit videos; and
for the motion-rich data, comparing the relighting results of pseudo-albedo videos to corresponding lit videos.

10. The method of claim 9, wherein comparing the relighting results of the pseudo-albedo videos to the corresponding lit videos further comprises using reference-based conditioning on the relighting model by performing reference-based appearance copy to align frames of a resulting lit video with a reference lit frame.

11. The method of claim 9, wherein comparing the relighting results of the albedo videos to the corresponding lit videos further comprises at least one of:
using reference-based conditioning; or
using HDR-based conditioning with an environment HDR map.

12. The method of claim 1, wherein the de-lighting model and the relighting model are trained by performing an iterative process to generate subsequent frames based on previous predictions, wherein a step of the iterative process replaces a number of initial frames of a video segment with the previous predictions, updates masks for the number of initial frames, and predicts remaining frames of the video segment.

13. The method of claim 1, wherein generating the relit video comprises:
encoding the input HDR map as light embeddings;
deriving and concatenating input latents, binary masks, and noise latents over time for the albedo video;
inputting the light embeddings and the concatenation to a denoising neural network trained to predict noise to reconstruct videos by minimizing mean squared error between noise predictions and ground truth using specialized layers operating in latent space;
deriving relit latents from the denoising neural network; and
constructing the relit video using the relit latents.

14. The method of claim 13, wherein encoding the input HDR map as light embeddings comprises:
tokenizing images of the input HDR map by predicting directional lighting;
encoding the tokenized images as light embeddings using a multilayer perceptron (MLP) and concatenating with positional encodings representing each light's average direction, wherein each light embedding represents a single directional light source; and
inputting the light embeddings to the denoising neural network through cross-attention layers.

15. The method of claim 13, wherein the input latents comprise at least one of:
latents of the albedo video; or
latents of relit frames of previous predictions.

16. A system comprising:
a reception module, stored in memory, that receives, by a computing device, an original video to relight;
a de-lighting module, stored in memory, that predicts, by the computing device using a de-lighting model trained on a hybrid dataset of lighting-rich data and motion-rich data, an albedo video corresponding to the original video;
a relighting module, stored in memory, that generates, by the computing device using a relighting model trained on the hybrid dataset, a relit video based on the albedo video under a specified lighting condition based on an input HDR map; and
at least one processor that executes the reception module, the de-lighting module, and the relighting module.

17. The system of claim 16, wherein the lighting-rich data comprises:
a set of lit videos comprising synthetic videos derived from applying camera effects to a set of OLAT images;
a set of corresponding albedo videos comprising synthetic videos derived from applying camera effects to a set of flat-lit images corresponding to the set of OLAT images; and
a set of environment HDR maps randomly paired with the set of lit videos.

18. The system of claim 16, wherein the motion-rich data comprises:
a set of lit videos comprising in-the-wild videos with diverse motion patterns and diverse lighting; and
a set of corresponding albedo videos comprising pseudo-albedo videos derived from the set of lit videos using an image-based de-lighting model for each frame of each lit video.

19. The system of claim 16, wherein the relighting module generates the relit video by:
encoding the input HDR map as light embeddings;
deriving and concatenating input latents, binary masks, and noise latents over time for the albedo video;
inputting the light embeddings and the concatenation to a denoising neural network trained to predict noise to reconstruct videos by minimizing mean squared error between noise predictions and ground truth using specialized layers operating in latent space;
deriving relit latents from the denoising neural network; and
constructing the relit video using the relit latents.

20. A non-transitory computer-readable medium comprising one or more computer-executable instructions that, when executed by at least one processor of a computing device, cause the computing device to:
receive, by the computing device, an original video to relight;
predict, by the computing device using a de-lighting model trained on a hybrid dataset of lighting-rich data and motion-rich data, an albedo video corresponding to the original video; and
generate, by the computing device using a relighting model trained on the hybrid dataset, a relit video based on the albedo video under a specified lighting condition based on an input HDR map.
